(19) United States
(12) Patent Application Publication
(10) Pub. No.: US 2020/0174773 A1
(43) Pub. Date: Jun. 4, 2020

(54) INTELLIGENT AUTOMATED REMOTE CODE LOAD

(71) Applicant: International Business Machines Corporation, Armonk, NY (US)

(72) Inventors: Matthew G. Borlick, Tucson, AZ (US); Lokesh M. Gupta, Tucson, AZ (US); Micah Robison, Tucson, AZ (US); Edward Lin, Tucson, AZ (US)

(73) Assignee: International Business Machines Corporation, Armonk, NY (US)

(21) Appl. No.: 16/209,962

(22) Filed: Dec. 4, 2018

(51) Int. Cl. G06F 8/65; H04L 29/08; G06F 11/34

(52) U.S. Cl. CPC G06F 8/65; G06F 11/34; H04L 67/34

(57) ABSTRACT

A method for updating code in a set of machines is disclosed. In one embodiment, such a method includes receiving a time range within which a code update is to be performed on a set of machines, block out times indicating when the code update cannot be performed, and an order in which the code update is to be performed on the set of machines. For some time period before the code update is performed, the method gathers I/O statistics associated with the set of machines. The method then performs the code update on the set of machines during a period of reduced I/O as determined from the I/O statistics, while complying with the received time range, block out times, and order. A corresponding system and computer program product are also disclosed.

### BACKGROUND

### Field of the Invention

This invention relates to systems and methods for updating code in enterprise storage systems.

### Background of the Invention

In an enterprise storage system such as the IBM DS8000™ enterprise storage system, a pair of servers may be used to access data in one or more storage drives (e.g., hard-disk drives and/or solid-state drives). During normal operation (when both servers are operational), the servers may manage I/O to different logical subsystems (LSSs) within the enterprise storage system. For example, in certain configurations, a first server may handle I/O to even LSSs, while a second server may handle I/O to odd LSSs. These servers may provide redundancy and ensure that data is always available to connected hosts. When one server fails, the other server may pick up the I/O load of the failed server to ensure that I/O is able to continue between the hosts and the storage drives. This process may be referred to as a “failover.”

In enterprise storage systems such as the IBM DS8000™, microcode on the storage system may need to be periodically updated to ensure that the storage system is configured with the latest fixes and features. These updates are often performed concurrently, meaning that the code is updated on a storage system without disrupting its operation. Unfortunately, updating microcode on a storage system often requires an on-site technician to perform the update. This can be very expensive and time-consuming. The expense may be multiplied in situations where microcode needs to be updated on multiple related machines at multiple sites.

Although software exists to update code automatically, this software is often not very intelligent. For example, software-initiated code loads often do not take into account dependencies or relationships between primary, secondary, and possibly tertiary storage systems. Automated software also typically does not determine the best times to update code based on historical data access rates on the related storage systems. As a result, code loads may be performed on storage systems in non-optimal orders or at inopportune times.

In view of the foregoing, what are needed are systems and methods to more intelligently perform automated code loads on storage systems. Ideally, such systems and methods will take into account relationships or dependencies between storage systems. Further needed are systems and methods to automatically perform code loads at optimal times based on historical data access rates.

### SUMMARY

The invention has been developed in response to the present state of the art and, in particular, in response to the problems and needs in the art that have not yet been fully solved by currently available systems and methods. Accordingly, systems and methods have been developed to update code in a set of machines such as a set of storage systems. The features and advantages of the invention will become more fully apparent from the following description and appended claims, or may be learned by practice of the invention as set forth hereinafter.

Consistent with the foregoing, a method for updating code in a set of machines is disclosed. In one embodiment, such a method includes receiving a time range within which a code update is to be performed on a set of machines, block out times indicating when the code update cannot be performed, and an order in which the code update is to be performed on the set of machines. For some time period before the code update is performed, the method gathers I/O statistics associated with the set of machines. The method then performs the code update on the set of machines during a period of reduced I/O as determined from the I/O statistics, while complying with the received time range, block out times, and order.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a network environment in which systems and methods in accordance with the invention may be implemented;

FIG. 2 is a high-level block diagram showing one example of a storage system for use in the network environment of FIG. 1;

FIG. 3 is a high-level block diagram showing a system for remotely updating code in a set of storage systems;

FIG. 4 is a high-level block diagram showing propagation of code updates to storage systems in the set;

FIG. 5 is a flow diagram showing one embodiment of a method for defining a code load request; and

FIG. 6 is a flow diagram showing one embodiment of a method for executing a code load request.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

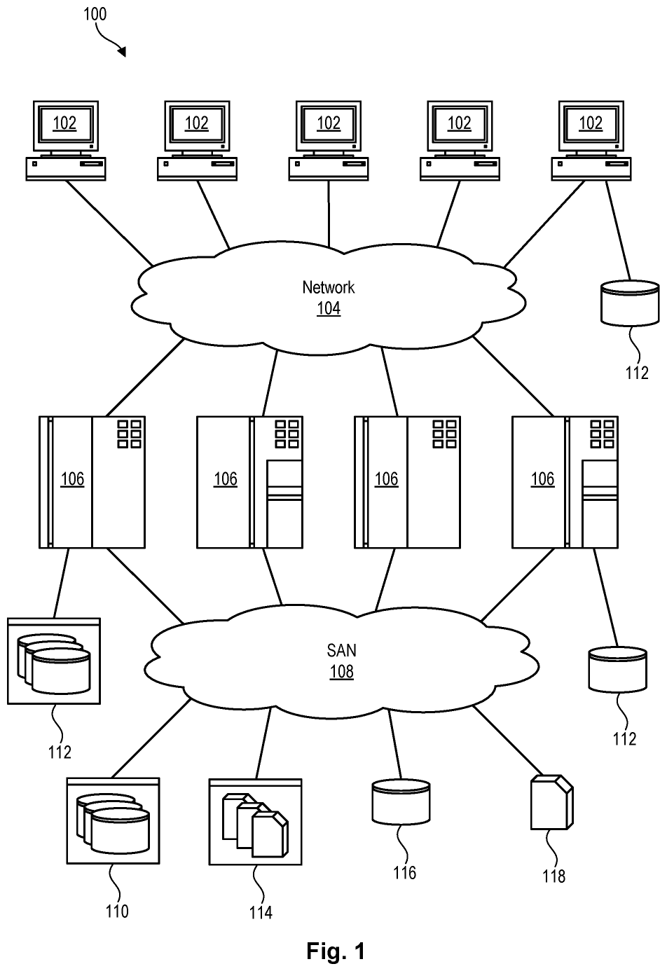

Referring to FIG. 1, one example of a network environment 100 is illustrated. The network environment 100 is presented to show one example of an environment where embodiments of the invention may operate. The network environment 100 is presented only by way of example and not limitation. Indeed, the systems and methods disclosed herein may be applicable to a wide variety of different network environments in addition to the network environment 100 shown.

As shown, the network environment 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “hosts” 106 or “host systems” 106). In general, the client computers 102 initiate communication sessions, whereas the server computers 106 wait for and respond to requests from the client computers 102. In certain embodiments, the computers 102 and/or servers 106 may connect to one or more internal or external direct-attached storage systems 112 (e.g., arrays of hard-disk drives, solid-state drives, tape drives, etc.). These computers 102, 106 and direct-attached storage systems 112 may communicate using protocols such as ATA, SATA, SCSI, SAS, Fibre Channel, or the like.

The network environment 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems, such as arrays 110 of hard-disk drives or solid-state drives, tape libraries 114, individual hard-disk drives 116 or solid-state drives 116, tape drives 118, CD-ROM libraries, or the like. To access a storage system 110, 114, 116, 118, a host system 106 may communicate over physical connections from one or more ports on the host 106 to one or more ports on the storage system 110, 114, 116, 118. A connection may be through a switch, fabric, direct connection, or the like. In certain embodiments, the servers 106 and storage systems 110, 114, 116, 118 may communicate using a networking standard such as Fibre Channel (FC) or iSCSI.

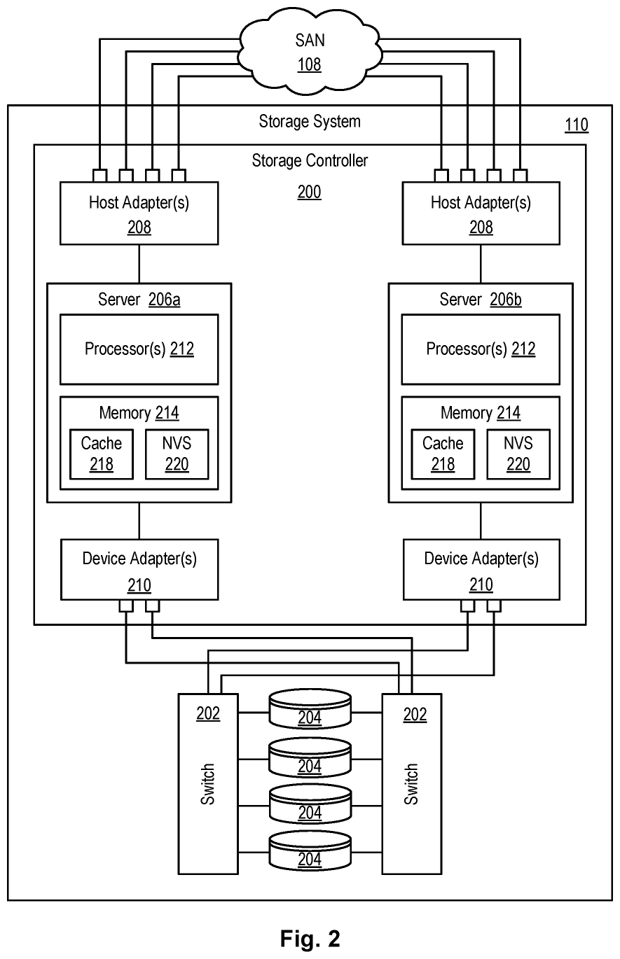

Referring to FIG. 2, one embodiment of a storage system 110 containing an array of storage drives 204 (e.g., hard-disk drives and/or solid-state drives) is illustrated. As shown, the storage system 110 includes a storage controller 200, one or more switches 202, and one or more storage drives 204 such as hard disk drives and/or solid-state drives (such as flash-memory-based drives). The storage controller 200 may enable one or more hosts 106 (e.g., open system and/or mainframe servers 106) to access data in the one or more storage drives 204.

In selected embodiments, the storage controller 200 includes one or more servers 206. The storage controller 200 may also include host adapters 208 and device adapters 210 to connect the storage controller 200 to host devices 106 and storage drives 204, respectively. During normal operation (when both servers 206 are operational), the servers 206 may manage I/O to different logical subsystems (LSSs) within the enterprise storage system 110. For example, in certain configurations, a first server 206a may handle I/O to even LSSs, while a second server 206b may handle I/O to odd LSSs. These servers 206a, 206b may provide redundancy to ensure that data is always available to connected hosts 106. Thus, when one server 206a fails, the other server 206b may pick up the I/O load of the failed server 206a to ensure that I/O is able to continue between the hosts 106 and the storage drives 204. This process may be referred to as a “failover.”

In selected embodiments, each server 206 includes one or more processors 212 and memory 214. The memory 214 may include volatile memory (e.g., RAM) as well as non-volatile memory (e.g., ROM, EPROM, EEPROM, flash memory, local disk drives, local solid state drives etc.). The volatile and non-volatile memory may, in certain embodiments, store software modules that run on the processor(s) 212 and are used to access data in the storage drives 204. These software modules may manage all read and write requests to logical volumes in the storage drives 204.

In selected embodiments, the memory 214 includes a cache 218, such as a DRAM cache 218. Whenever a host 106 (e.g., an open system or mainframe server 106) performs a read operation, the server 206 that performs the read may fetch data from the storages drives 204 and save it in its cache 218 in the event it is required again. If the data is requested again by a host 106, the server 206 may fetch the data from the cache 218 instead of fetching it from the storage drives 204, saving both time and resources. Similarly, when a host 106 performs a write, the server 106 that receives the write request may store the write in its cache 218, and destage the write to the storage drives 204 at a later time. When a write is stored in cache 218, the write may also be stored in non-volatile storage (NVS) 220 of the opposite server 206 so that the write can be recovered by the opposite server 206 in the event the first server 206 fails. In certain embodiments, the NVS 220 is implemented as battery-backed volatile memory in the opposite server 206.

One example of a storage system 110 having an architecture similar to that illustrated in FIG. 2 is the IBM DS8000™ enterprise storage system. The DS8000™ is a high-performance, high-capacity storage controller providing disk and solid-state storage that is designed to support continuous operations. Nevertheless, the systems and methods disclosed herein are not limited to the IBM DS8000™ enterprise storage system 110, but may be implemented in any comparable or analogous storage system or group of storage systems, regardless of the manufacturer, product name, or components or component names associated with the system. Any storage system that could benefit from one or more embodiments of the invention is deemed to fall within the scope of the invention. Thus, the IBM DS8000™ is presented only by way of example and is not intended to be limiting.

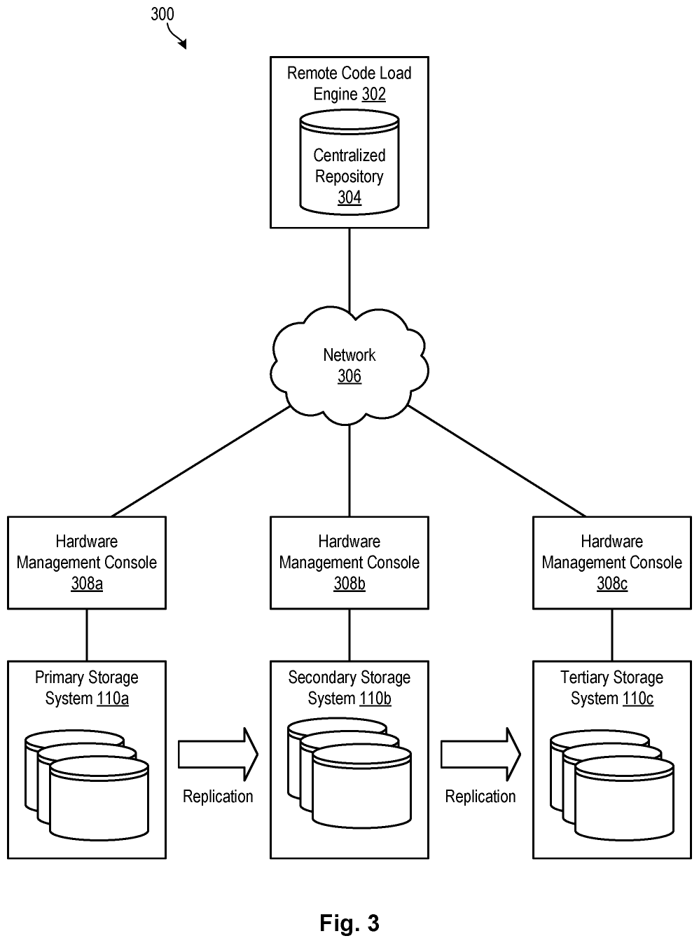

Referring to FIG. 3, in enterprise storage systems 110 such as the IBM DS8000™, code (e.g., microcode) on the storage system 110 may need to be periodically updated to ensure that the storage system 110 is configured with the latest fixes and features. These updates may be performed concurrently, meaning that the code may be updated on the storage system 110 without disrupting its operation. In certain embodiments, this may be accomplished by routing all I/O through one server 206a while the other server 206b is being updated, and vice versa. Unfortunately, updating the code on a storage system 110 often requires an on-site technician to perform the update. This can be very expensive and time-consuming. This expense may be multiplied when there are multiple related machines 110 at multiple sites that need to be updated.

Although software exists to update code automatically, this software is often not very intelligent. For example, automated code loads often do not take into account dependencies or relationships between primary, secondary, and possibly tertiary storage systems 110. Automated software also typically does not determine the best times to update code based on historical data access rates on the storage systems 110. As a result, code loads may be performed on storage systems 110 in non-optimal orders or at inopportune times.

In view of the foregoing, systems and methods are needed to more intelligently update code on storage systems 110. Ideally, such systems and methods will take into account dependencies or relationships of storage systems 110. Further needed are systems and methods to automatically perform code loads at optimal times based on historical data access rates. One example of such systems and methods are disclosed in FIGS. 3 through 6.

FIG. 3 shows one embodiment of a system 300 for remotely updating code on a set of storage systems 110a-c. As shown, the storage systems 110a-c include a primary, secondary, and optionally tertiary storage system. These storage systems 110a-c may be arranged in various configuration. For example, data may be written to a primary storage system 110a, which may then be replicated to a secondary storage system 110b, and then possibly to a tertiary storage system 110c.

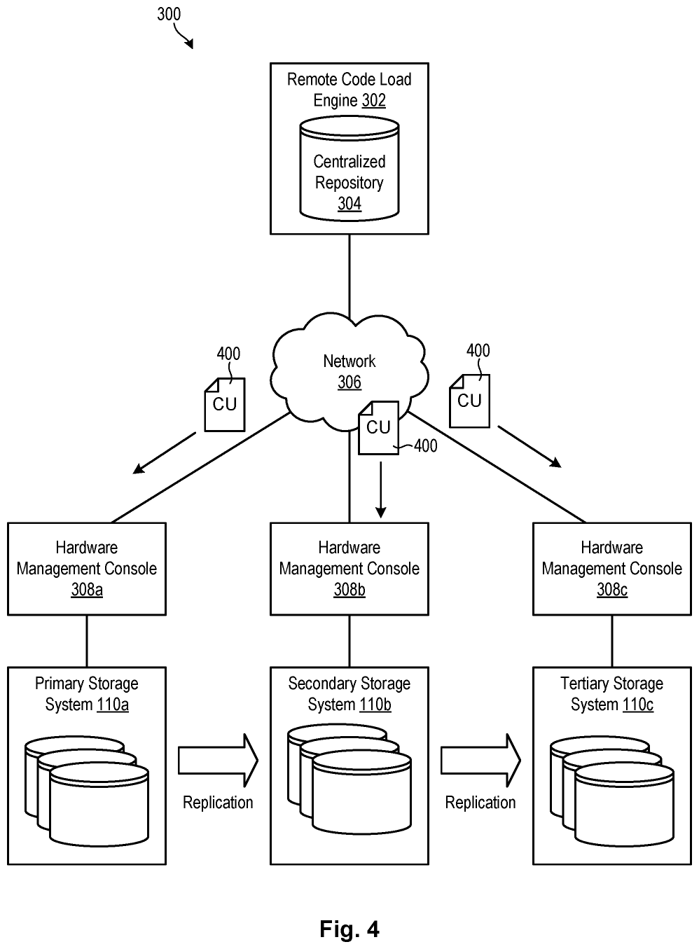

As shown, the system 300 may include a remote code load engine 302, such as a cloud-based remote code load engine 302. The remote code load engine 302 may, in certain embodiments, be operated by a service provider, such as a vendor of the storage systems 110a-c, to service and update storage systems 110a-c purchased by customers of the vendor. As shown, the remote code load engine 302 includes a centralized repository 304 that stores code updates for the storage systems 110a-c. In certain embodiments, these code updates 400 are transmitted to the storage systems 110a-c over a network 306 such as the Internet or an intranet, as shown in FIG. 4. In certain embodiments, the code updates 400 are communicated to hardware management consoles (HMCs) 308a-c associated with each storage system 110. These hardware management consoles 308a-c may, in turn, be used to update their respective storage systems 110a-c with the most recent code level.

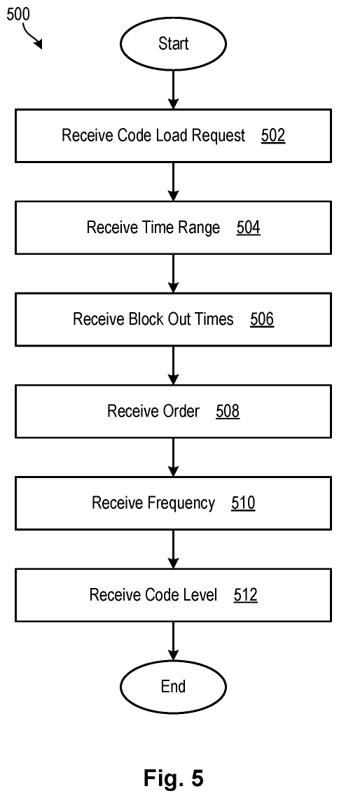

Referring to FIG. 5, in certain embodiments, a user may define a code load request and send the code load request to the remote code load engine 302. This code load request may set forth various parameters for performing future code loads on storage systems 110a-c as set forth by the method 500 of FIG. 5. For example, as shown in FIG. 5, the remote code load engine 302 may receive 502 a code load request. The remote code load engine 302 may receive 504, with the code load request, a time range over which the code load may be performed. This time range may include dates as well as times (e.g., June 15, 2 pm to June 18, 5 pm) when the code load may be performed.

The remote code load engine 302 may also, in certain embodiments, receive 506 block out times in association with the code load request. For example, a banking customer may not want code updates to occur during banking business hours, such as 9 am to 5 pm on Monday through Friday. The block out times may indicate which days, times, and/or time ranges the code load is not to be performed.

In certain cases, related storage systems 110a-c such as those illustrated in FIGS. 3 and 4 may need to be updated in a particular order. This order may be needed to avoid disruptions, avoid outages, maintain data integrity, maintain data redundancy, and/or the like. Thus, in certain embodiments, the remote code load engine 302 may receive 508, as part of the code load request, an order in which to update code on the storage systems 110a-c. For example, a primary storage system 110a may need to be updated before a secondary storage system 110b, which may need to be updated before a tertiary storage system 110c. Each site (primary site, secondary site, tertiary site, etc.) may also have multiple storage systems 110 that need to be updated in a particular order.

The remote code load engine 302 may also receive 510, as part of the code load request, a frequency with which to perform code updates on the storage systems 110 (e.g., every six months, every twelve months, etc.). Additionally, the remote code load engine 302 may also receive 512, as part of a code load request, information regarding a code level with which to update a storage system 110 or a group of storage systems 110a-c. This code level may be expressed, for example, as a version or bundle number that may need to be installed on a particular storage system 110 or group of storage systems 110a-c.

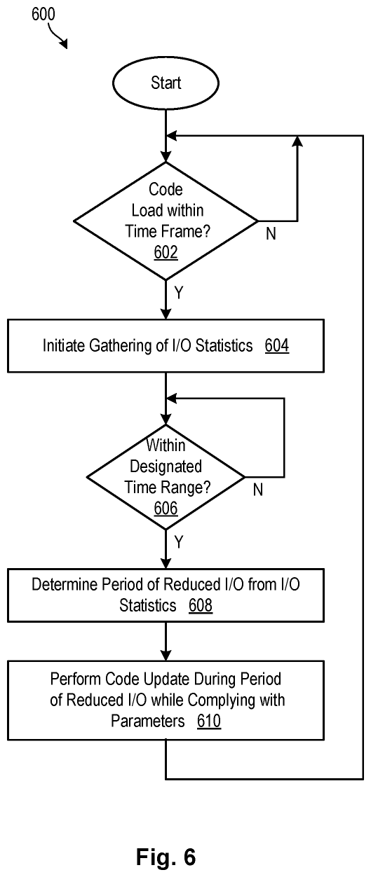

Referring to FIG. 6, one embodiment of a method 600 for processing or executing a code load request is illustrated. As shown, a remote code load engine 302 may initially determine 602 whether a current time is within a certain time frame of a code load associated with a code load request. For example, this step may determine 602 whether a code load is scheduled to occur within a certain amount of time (e.g., one month) from the current time. If so, the remote code load engine 302 may initiate 604 the gathering of input/output (I/O) statistics for the storage systems 110a-c on which the code load is to be performed. These I/O statistics (e.g., I/O operations per second, data access rates, etc.) may be gathered at designated intervals and stored in association with the code load request. In certain embodiments, these I/O statistics may be gathered until the code load is actually performed. Alternatively, each storage system 110 may be configured to periodically gather and save I/O statistics for up to a designated amount of time (e.g., one month) so that these statistics are available for a code load at any given point in time.

The remote code load engine 302 may then determine 606 whether a current time is within the time range designated in the code load request. That is, the remote code load engine 302 may determine 606 whether the current time is within the dates, times, and/or time ranges designated in the code load request to perform the code load. If so, the remote code load engine 302 may determine 608, from the I/O statistics, a period of reduced I/O on the storage system(s) 110. That is, the remote code load engine 302 may determine which periods, within the dates, times, and/or time ranges associated with the code load request, are associated with reduced levels of I/O on the storage system(s) 110 associated with the code load request. This may be accomplished by analyzing the I/O statistics gathered for the time period (e.g., one month) prior to executing the code load request. In general, the remote code load engine 302 may look for periods of reduced I/O (preferably the lowest I/O) in which to perform the code load on the storage system(s) 110.

The remote code load engine 302 may then perform 610 the code load during the period of reduced I/O determined at step 608. If the code load takes two hours, the remote code load engine 302 may look for a window of reduced I/O lasting two hours in which to perform the code load. In doing so, the remote code load engine 302 may comply with the parameters established in the method 500 of FIG. 5. That is, the remote code load engine 302 may ensure that the code load is not performed during the block out times established at step 506 and that the code load is performed on the storage system(s) 110 in the order designated at step 508. In certain embodiments, the code load may be performed on the storage system(s) 110 one at a time in the designated order. Once a code load is performed on a storage system 110, the remote code load engine 302 may mark the storage system 110 as having its code updated and move on to a next storage system 110 in a set of storage systems 110a-c.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for updating code in a set of machines, the method comprising:
receiving a code load request configured to be processed by a code load engine, the code load request having the following parameters:
a time range within which a code update is to be performed on a set of machines;
block out times indicating when the code update cannot be performed; and
a designated order in which the code update is be performed on the set of machines;
before the code update is performed, gathering I/O statistics on the set of machines; and
executing, by the code load engine, the code load request by performing the code update on the set of machines during a period of time determined from the I/O statistics, while complying with the time range, block out times, and designated order.

2. The method of claim 1, wherein the set of machines is a set of storage systems.

3. The method of claim 2, wherein the set of storage systems comprises primary, secondary, and optionally tertiary storage systems.

4. The method of claim 1, further comprising initiating the code update from a location that is remote from the set of machines.

5. The method of claim 4, further comprising receiving, at the location, the time range, block out times, and designated order.

6. The method of claim 1, wherein performing the code update comprises performing the code update without disrupting operation of the set of machines.

7. The method of claim 1, wherein the period of time corresponds to an amount of time needed to perform the code load time range.

8. A computer program product for updating code in a set of machines, the computer program product comprising a computer-readable storage medium having computer-usable program code embodied therein, the computer-usable program code configured to perform the following when executed by at least one processor:
receive a code load request configured to be processed by a code load engine, the code load request having the following parameters:
a time range within which a code update is to be performed on a set of machines;
block out times indicating when the code update cannot be performed; and
a designated order in which the code update is be performed on the set of machines;
before the code update is performed, gather I/O statistics on the set of machines; and
execute, on the code load engine, the code load request by performing the code update on the set of machines during a period of time determined from the I/O statistics, while complying with the time range, block out times, and designated order.

9. The computer program product of claim 8, wherein the set of machines is a set of storage systems.

10. The computer program product of claim 9, wherein the set of storage systems comprises primary, secondary, and optionally tertiary storage systems.

11. The computer program product of claim 8, wherein the computer-usable program code is further configured to initiate the code update from a location that is remote from the set of machines.

12. The computer program product of claim 11, wherein the computer-usable program code is further configured to receive, at the location, the time range, block out times, and designated order.

13. The computer program product of claim 8, wherein performing the code update comprises performing the code update without disrupting operation of the set of machines.

14. The computer program product of claim 8, wherein the period of time corresponds to an amount of time needed to perform the code load.

15. A system for updating code in a set of machines, the system comprising:
at least one processor;
at least one memory device operably coupled to the at least one processor and storing instructions for execution on the at least one processor, the instructions causing the at least one processor to:
receive a code load request configured to be processed by a code load engine, the code load request having the following parameters:
a time range within which a code update is to be performed on a set of machines;
block out times indicating when the code update cannot be performed; and
a designated order in which the code update is be performed on the set of machines;
before the code update is performed, gather I/O statistics on the set of machines; and
execute, on the code load engine, the code load request by performing the code update on the set of machines during a period of time determined from the I/O statistics, while complying with the time range, block out times, and order.

16. The system of claim 15, wherein the set of machines is a set of storage systems.

17. The system of claim 16, wherein the set of storage systems comprises primary, secondary, and optionally tertiary storage systems.

18. The system of claim 15, wherein the instructions further cause the at least one processor to initiate the code update from a location that is remote from the set of machines.

19. The system of claim 18, wherein the instructions further cause the at least one processor to receive, at the location, the time range, block out times, and designated order.

20. The system of claim 15, wherein performing the code update comprises performing the code update without disrupting operation of the set of machines.
